(19) United States
(12) Patent Application Publication
(10) Pub. No.: US 2003/0135854 A1
(43) Pub. Date: Jul. 17, 2003

(54) Method of and apparatus for bookmarking channels

(75) Inventor: Jung-won Lee, Seoul (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-City (KR)

(21) Appl. No.: 10/324,115

(22) Filed: Dec. 20, 2002

(30) Foreign Application Priority Data
Dec. 20, 2001 (KR) 2001-81779

(51) Int. Cl. H04N 7/16; H04H 9/00; G06F 3/00; H04N 5/445; G06F 13/00

(52) U.S. Cl. 725/38; 725/9

(57) ABSTRACT

A method of and an apparatus for bookmarking channels include a key input unit, which receives a key input for selecting and storing channels by a user, a first memory, which stores at least one channel preferred by the user and input from the key input unit, a second memory, which stores at least one temporary channel input from the key input unit, and a controller which provides an all-channel selection mode, during which all channels are flipped until the user selects one of the flipped channels, a preferred-channel selection mode, during which only the channels stored in the first memory are flipped until the user selects one of them, and a temporary-channel selection mode, during which only the channels stored in the second memory are flipped until the user selects one of the stored channels. Here, controlling the channel flipping is effective for a predetermined period of time and the memory is cleared to erase the temporarily stored channels after the predetermined period of time.

### CROSS-REFERENCE TO RELATED APPLICATIONS

This application claims the benefit of Korean Patent Application No. 2001-81779, filed Dec. 20, 2001, in the Korean Intellectual Property Office, the disclosure of which is incorporated herein by reference.

### BACKGROUND OF THE INVENTION

1. Field of the Invention

The present invention relates to a method of and an apparatus for selecting a broadcast channel, and more particularly, to a method of and an apparatus for bookmarking channels to allow the channels bookmarked by a user to be automatically selected when a broadcast receiver is turned on.

2. Description of the Related Art

With the proliferation of digital broadcasting using satellites, the number of program channels provided to users has been increasing and will continue to increase. In order to keep pace with a multiple-channel era, an electronic program guide (EPG) service has been introduced to help the users choose channels by viewing information on broadcast (program) channels provided to the users in advance. In addition, broadcasting receivers (digital TVs or set top boxes) have been manufactured to provide various methods of helping the users to select the channels. For example, there is a method of selecting channels to allow a user to select and store desired channels and then flip through only the desired channels. According to this method, the user can select any channel the user wishes to watch while flipping through the channels selected by the user in advance, instead of flipping through all channels. As for another method of helping the user to select channels, a predetermined period of time, during which the user has been watching channels, is measured so that the channels which the user has been watching for more than the predetermined period of time are automatically classified and stored as preferred channels. Accordingly, the user can select a channel by flipping through the preferred channels.

However, in the methods of helping the user select the channels, which are provided by the broadcasting receivers, once the user selects the preferred channels, the user can only flip through those preferred channels until new preferred channels are manually or automatically selected.

For example, if the user selects a drama channel and a movie channel as the preferred channels and wishes to watch a certain sports event program on a certain day, the user has to repeatedly press an up or down button of a remote controller until one of the preferred channels or a sports channel broadcasting the certain sports event program is selected, so as to change the channels between the preferred channels and the sports channel. Alternatively, the user may set up the sports channel as a preferred channel, and the user is supposed to always flip through all the preferred channels including the sports channel that the user usually does not prefer to watch even after the certain day or the user has to delete the sports channel from a list of the preferred channels.

### SUMMARY OF THE INVENTION

To solve the above and other problems, it is an aspect of the present invention to provide a method of and an apparatus for bookmarking channels to allow a user to flip through only preferred channels selected by the user during a predetermined period of time.

Additional aspects and advantages of the invention will be set forth in part in the description which follows and, in part, will be obvious from the description, or may be learned by practice of the invention.

Accordingly, to achieve the above and/or other aspects of the present invention, a method of bookmarking channels of an apparatus for receiving broadcast programs includes storing at least one preferred channel and setting a predetermined period of time during which only the at least one preferred channel can be selected.

It is possible that the predetermined period of time is as long as one session, for which the at least one preferred channel is selected, and the apparatus for receiving broadcast programs is turned on.

It is possible that the predetermined period of time is arbitrarily set by the apparatus for receiving broadcast programs.

It is possible that the predetermined period of time is set by inputting a beginning time and an ending time.

To achieve the above and/or other aspects of the present invention, an apparatus for bookmarking channels in an apparatus for receiving broadcast programs includes a key input unit which receives a key input for selecting and storing channels by a user, a memory which stores at least one channel preferred by the user and input from the key input unit, and a controller which controls channel flipping to be performed among the channels stored in the memory until the user selects one of the stored channels. Here, controlling the channel flipping is effective for a predetermined period of time, and the memory is cleared after the predetermined period of time.

It is possible that the key input unit receives a key input for canceling and deleting previously stored channels.

To achieve the above and/or other aspects of the present invention, a method of bookmarking channels in an apparatus for receiving broadcast programs includes setting a temporary-channel selection mode, during which channel flipping is performed among some channels for a predetermined period of time and allowing channel flipping to be performed among previously stored channels until a user selects one of the previously stored channels within the predetermined period of time when the user selects the temporary-channel selection mode.

To achieve the above and/or other aspects of the present invention, a method of bookmarking channels in an apparatus for receiving broadcast programs includes searching for all channels provided, selecting at least one preferred channel among all the provided channels, and allowing only the selected channels to be searched in a subsequent channel search after searching through all the provided channels.

It is possible that the channel search is performed manually or automatically.

It is possible that the method of bookmarking channels further includes canceling the selected channels for the subsequent channel search.

It is possible that the selected channels can be searched again only during a predetermined period of time.

### BRIEF DESCRIPTION OF THE DRAWINGS

The above and/or other aspects and advantages of the present invention will become more apparent and more readily appreciated from the following description of the preferred embodiments, taken in conjunction with the accompanying drawings of which:

FIG. 1 is a block diagram of an apparatus for bookmarking channels in an apparatus for receiving and reproducing broadcast programs according to an embodiment of the present invention;

FIG. 2 is a flowchart of a method of bookmarking channels, which is performed in the apparatus of FIG. 1; and

FIG. 3 is a detailed flowchart of a method of bookmarking channels, which is performed in the apparatus of FIG. 1.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described in order to explain the present invention by referring to the figures.

The present invention will now be described more fully with reference to the accompanying drawings.

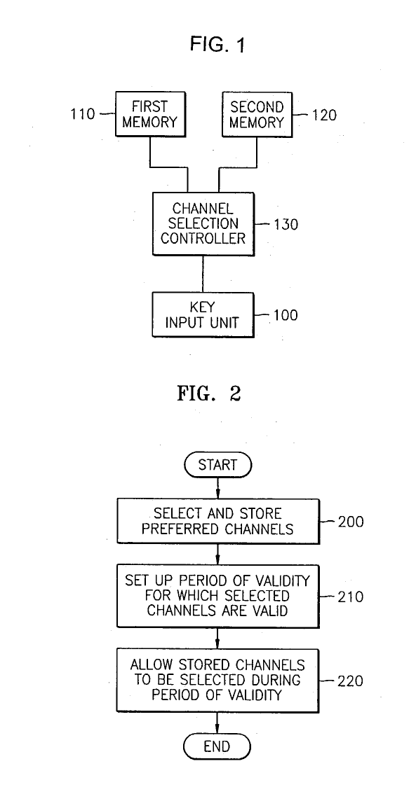

FIG. 1 is a block diagram of an apparatus for bookmarking channels in an apparatus for receiving and reproducing broadcast programs according to an embodiment of the present invention. The apparatus for receiving and reproducing broadcast programs includes a key input unit 100, a first memory 110, a second memory 120, and a channel selection controller 130.

The key input unit 100 allows a user to use keys to input commands for selecting and storing channels. The user directly inputs various commands for selecting channels into the key input unit 100 or transmits such commands to the key input unit 100 in a form of infrared ray signals using a remote controller. The key input unit 100 provides an all-channel selection mode, a preferred-channel selection mode, and a temporary-channel selection mode.

The first memory 110 stores preferred channels selected by the user using the key input unit 100. The preferred channels stored in the first memory 110 are selected from among all channels according to the user's preference. When the preferred-channel selection mode is selected using the key input unit 100, the user can flip through only the channels stored in the first memory 110.

The second memory 120 stores temporary channels selected by the user using the key input unit 100. When the temporary-channel mode is selected using the key input unit 100, the user can flip through only the temporary channels stored in the second memory only for a predetermined period of time.

The channel selection controller 130 selects a channel mode or a channel selection mode in response to a selection command input into the key input unit 100 and determines whether data stored in the first memory 110 or the second memory 120 will be read, according to the selected channel selection mode.

An operation of flipping through channels and selecting the channels via the apparatus for bookmarking channels will be described in the following paragraphs.

Using the key input unit 100, the user can select all broadcast channels provided to the apparatus for receiving and reproducing the broadcast programs. For example, when the channels are numbered from 1 to 100, and the user inputs a channel flipping command for flipping through the channels into the key input unit 100, the channels are automatically flipped in a sequence of 1→2→3→ . . . →100→1→ . . . at intervals of a predetermined period of time or manually by the user controlling an up/down key of the key input unit 100 or the remote controller. This type of channel flipping is performed when the all-channel selection mode is selected using the key input unit 100.

However, the user may think it is inconvenient to flip through all the channels, especially when there are a great number of the channels. Accordingly, the user can select and store one or more channels as preferred channels by selecting the preferred-channel selection mode using the key input unit 100. When the user selects the preferred-channel selection mode using the key input unit 100, the stored preferred channels are read by the channel selection controller 130, and the user can flip through only the stored preferred channels. For example, supposing that the user selects and stores channels 3, 10, 20, 41, 50, and 70 in the first memory 110, in the preferred-channel selection mode, the channel flipping is performed in the order of 3→10→20→41→50→70→3→ . . . or in a reverse order of 70→50→41→20→10→3→70→ . . . by the user manipulating the key input unit 100 until the user selects one of the channels 3, 10, 20, 41, 50, and 70.

The aforementioned all-channel selection mode or the aforementioned preferred-channel selection mode may be employed and performed in the apparatus adopting the channel selection methods.

Unlike the all-channel selection mode or the preferred-channel selection mode, the temporary-channel selection mode enables the apparatus to temporarily store channels that are not always preferred by the user but are temporarily desired by the user on special occasions. The temporary channels are selected by the user and stored in the second memory 120 when the temporary-channel selection mode is selected using the key input unit 100. Thereafter, when the temporary-channel selection mode is selected using the key input unit 100, the channel selection controller 130 allows only the channels stored in the second memory 120 to be flipped. For example, supposing the user selects channels 45, 67, and 88 and stores the channels in the second memory 120, channel flipping is performed in the order of 45→67→88→45→ . . . or in a reverse order of 88→67→45→88→ . . . automatically or manually by the user's key manipulation until the user selects one of the channels 45, 67, and 88.

The temporary channels stored in the second memory 120 are valid only for a predetermined period of time. After the predetermined period of time has passed, the temporary channels stored in the second memory 120 are automatically deleted. In order to save the predetermined period of time, for which the channels stored in the second memory 120 are valid, a third memory may be included in the apparatus for bookmarking channels. The predetermined period of time may be automatically set as long as a power-on session during the time when the temporary-channel selection mode is selected or may be manually set by the user inputting a predetermined beginning time and a predetermined ending time.

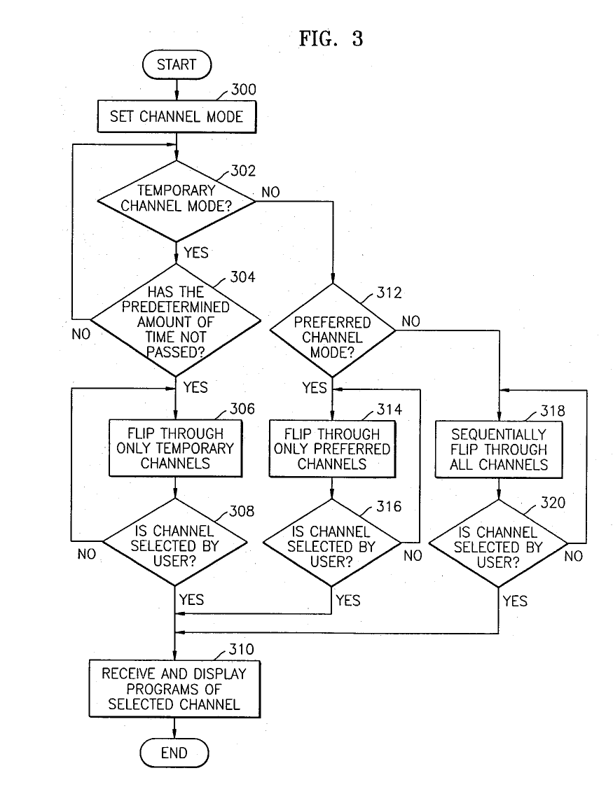

FIG. 2 is a flowchart of a method of bookmarking channels, which is performed in the apparatus of the FIG. 1. Referring to FIGS. 1 and 2, the user selects one or more channels, which the user prefers, using the key input unit 110 and stores the selected channels in operation 200. Next, in operation 210, the user sets a period of validity for which only the selected channels are stored and flipped in the predetermined channel selection mode. Here, the period of validity may be set as long as a power-on session or may be set between the beginning time and the ending time designated by the user. During the period of validity, the user flips through only the selected channels so that he or she can choose one of the selected channels, in step 220.

FIG. 2 shows a process of setting the temporary-channel selection mode, and FIG. 3 is a detailed flowchart of the method of bookmarking channels, which is performed in the apparatus of FIG. 1.

Referring to FIGS. 1 and 3, one of the all-channel selection mode, the preferred-channel selection mode, and the temporary-channel selection mode is selected by the user through the key input unit 100 in operation 300. When the temporary-channel selection mode is selected, the predetermined period of time, for which the temporary channels can be selected, is also set. The predetermined period of time may be set by the user or may be automatically determined to last as long as the power-on session when the temporary-channel selection mode is selected.

Whether a current channel selection mode is a temporary-channel selection mode is verified in operation 302. Then, verification of whether or not the predetermined period of time has passed takes place in operation S304. If the predetermined period of time has not yet passed, the temporary channels are flipped automatically at intervals of a predetermined period of time or are flipped manually by the user's key manipulation, in operation 306. When the user selects one of the temporary channels during the temporary channels are being flipped, in operation 306, the broadcast program of the selected channel is received and displayed in operation 310. When the current channel selection mode is the preferred-channel selection mode in operation 312, the channels having been set up as the preferred channels are flipped automatically at intervals of the predetermined period of time or manually by the user using the up/down or other key in operation 314, during which the user selects one of the channels being flipped in operation 316, the broadcast program of the selected channel is displayed on a screen of the apparatus in operation 310.

If the current channel selection mode is neither the temporary-channel selection mode nor the preferred-channel selection mode, the current channel selection is considered an all-channel selection mode. In the all-channel selection mode, all channels provided to the apparatus for receiving and reproducing broadcast programs are sequentially flipped automatically at intervals of the predetermined period of time or manually by a user's key manipulation in operation 318. When the user selects one of the channels during flipping through the channels in operation 320, the broadcast program of the selected channel is received through a receiving unit (not shown) from an external source and displayed on the screen of the apparatus in operation 310.

A method of bookmarking channels will be described in the following paragraphs in conjunction with FIGS. 1 through 3. The user can flip through all the broadcast channels sequentially using the remote controller. Here, the channel flipping may be performed manually from one channel to another by the user repeatedly pressing the up/down or other button or the channels are set to be flipped automatically from one channel to another at intervals of several seconds by pressing a predetermined key input button of the remote controller or the key input unit 100. Some of the channels may be selected from the flipped channels using another predetermined key input button so that the user can view the selected channels again later. The selected channels are stored in a buffer having a temporary storing function.

If the user presses a channel search button in order to search for channels again after briefly viewing all the channels, the user can only flip through the channels stored in the buffer. For repeated searches, another button for canceling the selection of the channels stored in the buffer may be further provided. If the user presses the channel canceling button, the channels stored in the buffer are deleted so that they will not be searched in a following search. Alternatively, the user inputs the predetermined period of validity so as to prevent the channels stored in the buffer from being erased from a list of channels to be searched for the predetermined period of validity. The predetermined period of validity may be set by the user or may be automatically set to last as long as the power-on session. Alternatively, the predetermined period of validity may be set by a predetermined period setting function of the apparatus for receiving and reproducing broadcast programs.

In the channel selection method, the user can search for channels among the preferred channels, which have been selected by the user in advance, for the predetermined period of time when multiple broadcast channels are provided. Accordingly, it is possible for the user to search for channels quickly and easily.

According to the present invention, it is possible to help a user select channels effectively and conveniently.

Although a few preferred embodiments of the present invention have been shown and described, it would be appreciated by those skilled in the art that changes may be made in this embodiment without departing from the principles and sprit of the invention, the scope of which is defined in the claims and their equivalents.

What is claimed is:

1. A method of bookmarking channels in an apparatus for receiving broadcast programs, the method comprising:
storing at least one temporary channel; and
setting a predetermined period of time during which only the at least one temporary channel is selectable.

2. The method of claim 1, wherein the predetermined period of time is one session, for which the at least one temporary channel is selected, and the apparatus for receiving broadcast programs is turned on.

3. The method of claim 1, wherein the predetermined period of time is arbitrarily set.

4. The method of claim 1, wherein the predetermined period of time comprises:
a beginning time and an ending time.

5. An apparatus for bookmarking channels in an apparatus for receiving broadcast programs, comprising:
a key input unit which receives a key input selecting and storing channels;
a memory which stores the selected channels in response to the key input from the key input unit; and
a controller which controls channel flipping to be performed among the channels stored in the memory until one of the stored channels is selected,
wherein the controlling of the channel flipping is effective for a predetermined period of time, and the memory is cleared after the predetermined period of time.

6. The apparatus of claim 5, wherein the predetermined period of time is one session, during which a temporary-channel selection mode is set, and the apparatus for receiving broadcast programs is turned on.

7. The apparatus of claim 5, wherein the predetermined period of time is arbitrarily set.

8. The apparatus of claim 5, wherein the predetermined period of time comprises:
a beginning time and an ending time.

9. The apparatus of claim 5, wherein the key input unit receives a key input canceling and deleting the stored channels.

10. A method of bookmarking channels in an apparatus for receiving broadcast programs, the method comprising:
setting a temporary-channel selection mode, during which channel flipping is performed among the channels for a predetermined period of time; and
allowing the channel flipping to be performed among the channels until one of the channels is selected within the predetermined period of time when the temporary-channel selection mode is selected.

11. The method of claim 10, wherein the predetermined period of time is one session, during which the temporary-channel selection mode is set, and the apparatus for receiving broadcast programs is turned on.

12. The method of claim 10, wherein the predetermined period of time is arbitrarily set.

13. The method of claim 10, wherein the predetermined period of time comprises:
a beginning time and an ending time.

14. A method of bookmarking channels in an apparatus for receiving broadcast programs, the method comprising:
searching for all channels provided;
selecting a preferred channel among the provided channels; and
allowing the selected preferred channel to be searched in a subsequent channel search after searching through all the provided channels.

15. The method of claim 14, wherein the channel search is performed manually or automatically.

16. The method of claim 14 further comprising:
canceling the selected channel for the subsequent channel search.

17. The method of claim 14, wherein the selected channels is selectable again only during a predetermined period of time.

18. The method of claim 17, wherein the predetermined period of time is one session, during which the channel is selected, and the apparatus for receiving broadcast programs is turned on.

19. The method of claim 17, wherein the predetermined period of time is arbitrarily set.

20. The method of claim 17, wherein the apparatus comprises a memory, and the predetermined period of time is set in the memory by the apparatus for receiving broadcast programs.
